(19) United States
(12) Patent Application Publication
(10) Pub. No.: US 2025/0238033 A1
(43) Pub. Date: Jul. 24, 2025

(54) MULTI-UNMANNED AERIAL VEHICLE (UAV) COOPERATIVE COVERAGE PATH PLANNING METHODS BASED ON IMPROVED ANT COLONY ALGORITHM WITH Q-LEARNING ADAPTIVE STRATEGY

(71) Applicant: ZHONGYUAN UNIVERSITY OF TECHNOLOGY, Zhengzhou (CN)

(72) Inventors: Boyang QU, Zhengzhou (CN); Xiaokang LI, Zhengzhou (CN); Xuzhao CHAI, Zhengzhou (CN); Pengwei WEN, Zhengzhou (CN); Zhao LI, Zhengzhou (CN); Baihao QIAO, Zhengzhou (CN); Li YAN, Zhengzhou (CN)

(73) Assignee: ZHONGYUAN UNIVERSITY OF TECHNOLOGY, Zhengzhou (CN)

(21) Appl. No.: 19/034,508

(22) Filed: Jan. 22, 2025

(30) Foreign Application Priority Data
Jan. 22, 2024 (CN) 202410085389.8

(51) Int. Cl. G05D 1/644; G05D 1/48; G05D 1/698; G05D 101/15; G05D 109/20; G05D 111/10; G05D 111/30; G06N 3/006

(52) U.S. Cl. CPC G05D 1/644; G05D 1/48; G05D 1/6987; G06N 3/006; G05D 2101/15; G05D 2109/20; G05D 2111/10; G05D 2111/32

(57) ABSTRACT

A system for UAV collaborative coverage path planning based on a Q-learning adaptive ant colony algorithm including a memory, an image collection device, and a plurality of UAVs loaded with a path planning module configured to: construct a 3D model in a collaborative coverage environment, by performing a cell division on the 3D model based on a scanning range of an airborne radar of each UAV, obtain one or more sub-regions; by establishing constraints of the UAV and the environment based on the determined 3D model of the region to be searched, establish a problem total cost model; perform a plurality of rounds of iterations, calculate a reward value of each ant colony and determine whether a maximum iteration count is reached, if the maximum iteration count is reached, enter a new round of iteration, otherwise, output a path corresponding to a current round of iteration as a final path.

### CROSS-REFERENCE TO RELATED APPLICATION

This application claims priority of Chinese Patent Application No. 202410085389.8, filed on Jan. 22, 2024, entitled “System for multi-unmanned aerial vehicle (UAV) collaborative coverage path planning based on a Q-learning adaptive ant colony algorithm”, the contents of each of which is entirely incorporated herein by reference.

### TECHNICAL FIELD

The present disclosure relates to the technical field of intelligent optimization, and in particular, relates to a multi-unmanned aerial vehicle cooperative coverage path planning method based on improved ant colony algorithm with Q-learning adaptive strategy.

### BACKGROUND

Unmanned aerial vehicles (UAVs) are increasingly used in cooperative coverage tasks. The cooperative coverage tasks require the UAVs to be able to efficiently and cooperatively plan paths to cover a search and rescue region, reduce energy consumption, and ensure drone safety. However, existing path planning methods are computationally intensive and complex, and tend to face many challenges when dealing with complex cooperative coverage tasks.

Therefore, it is desired to provide a multi-UAV cooperative coverage path planning method based on an improved ant colony algorithm with a Q-learning adaptive strategy to improve an efficiency and robustness of a cooperative planning of the UAVs in the cooperative coverage tasks.

### SUMMARY

One aspect of an embodiment of the present disclosure provides system for UAV collaborative coverage path planning based on a Q-learning adaptive ant colony algorithm. The system includes a memory, an image collection device, and a plurality of UAVs; and the memory is communicatively connected to the image collection device and the plurality of UAVs. The image collection device is configured to collect an environmental image of a region to be searched and store the environmental image to the memory. The plurality of UAVs are loaded with a path planning module configured to: construct a three-dimensional (3D) model in a collaborative coverage environment based on the environmental image through a first preset program obtained from the memory, obtain information of the region to be searched from the memory, and by performing a cell division on the 3D model based on a scanning range of an airborne radar of each of the plurality of UAVs, obtain one or more sub-regions; by establishing constraints of the plurality of UAVs and the environment based on the determined 3D model of the region to be searched, establish a problem total cost model; perform a plurality of rounds of iterations. Each round of iteration includes: setting an initial pheromone concentration based on the one or more sub-regions formed by the scanning range of the airborne radar, by solving the problem total cost model using a second preset program obtained from the memory, obtaining a preliminary planning path; the second preset program including an ant colony algorithm; and determining whether a count of iterations is greater than 1, in response to determining that the count of iterations is greater than 1, augmenting a pheromone using an elite strategy while adaptively adjusting a heuristic factor with a third preset program obtained from the memory; in response to determining that the count of iterations is not greater than 1, augmenting the pheromone using the elite strategy; the third preset program including a Q-learning. The path planning module is further configured to calculate a reward value of each ant colony and determine whether a maximum iteration count is reached, in response to determining that the maximum iteration count is reached, enter a new round of iteration, in response to determining that the maximum iteration count is reached, output a path corresponding to a current round of iteration as a final path.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, wherein:

FIG. 1 is a flowchart illustrating an exemplary method for multi-unmanned aerial vehicle (UAV) collaborative coverage path planning based on a Q-learning adaptive ant colony algorithm according to some embodiments of the present disclosure;

FIG. 2 is a schematic diagram illustrating a region map according to some embodiments of the present disclosure;

FIG. 3 is a model diagram illustrating an urban multi-region environment according to some embodiments of the present disclosure;

FIG. 4 is a schematic diagram illustrating a comparison of iterative reward values when there are two UAVs according to some embodiments of the present disclosure; where, (a) shows a reward value per generation for each algorithm when there are 8 regions, (b) shows the reward value per generation for each algorithm when there are 10 regions, (c) shows the reward value per generation for each algorithm when there are 12 regions, and (d) shows the reward value per generation for each algorithm when there are 14 regions;

FIG. 5 is a schematic diagram illustrating a comparison of iterative reward values when there are 3 UAVs according to some embodiments of the present disclosure, (a) shows a reward value per generation for each algorithm when there are 8 regions, (b) shows the reward value per generation for each algorithm when there are 10 regions, (c) shows the reward value per generation for each algorithm when there are 12 regions, and (d) shows the reward value per generation for each algorithm when there are 14 regions;

FIG. 6 is a schematic diagram illustrating a comparison of iterative reward values when there are 4 UAVs according to some embodiments of the present disclosure, where (a) shows a reward value per generation for each algorithm when there are 8 regions, (b) shows the reward value per generation for each algorithm when there are 10 regions, (c) shows the reward value per generation for each algorithm when there are 12 regions, and (d) shows the reward value per generation for each algorithm when there are 14 regions;

FIG. 7 is a schematic diagram illustrating a system for UAV collaborative coverage path planning based on a Q-learning adaptive ant colony algorithm according to some embodiments of the present disclosure;

FIG. 8 is a schematic diagram illustrating a process of determining a sampling point count according to some embodiments of the present disclosure;

FIG. 9 is a schematic diagram illustrating a process of determining a weight in a target function according to some embodiments of the present disclosure; and

FIG. 10 is a schematic diagram illustrating a process of determining a changing difference of a heuristic factor according to some embodiments of the present disclosure.

### DETAILED DESCRIPTION

The technical solutions in the embodiments of the present disclosure will be clearly and completely described below in conjunction with the accompanying drawings in the embodiments of the present disclosure, and it is clear that the embodiments described are only a portion of the embodiments of the present disclosure, and not all of the embodiments. Based on the embodiments in the present disclosure, all other embodiments obtained by a person of ordinary skill in the art without creative labor fall within the scope of protection of the present disclosure.

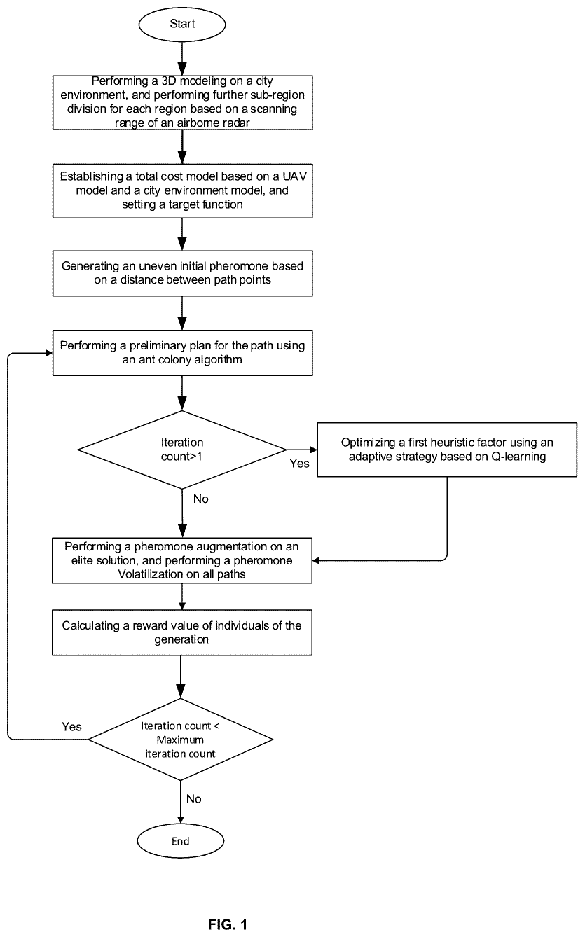

FIG. 1 is a flowchart illustrating an exemplary multi-unmanned aerial vehicle (UAV) cooperative coverage path planning method based on an improved ant colony algorithm with a Q-learning adaptive strategy according to some embodiments of the present disclosure.

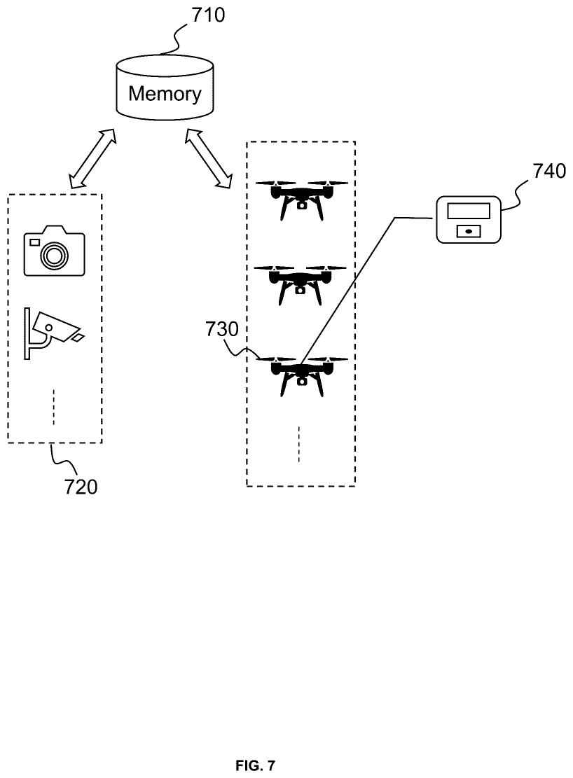

As shown in FIG. 1, some embodiments of the present disclosure provide a multi-UAV cooperative coverage path planning method based on an improved ant colony algorithm with a Q-learning adaptive strategy. The method solves a problem of multi-UAV cooperative search and rescue coverage path planning for a plurality of disaster-stricken regions in an urban environment. In some embodiments, the method is performed by a UAV-loaded path planning module. More descriptions of the path planning module may be found in FIG. 7 of the present disclosure and the related descriptions.

The method includes the following operations:

Step 1: a three-dimensional (3D) model in a cooperative coverage environment is constructed, information of a region to be searched is determined, the 3D model is divided into cells based on a scanning range of an airborne radar, and one or more sub-regions are obtained.

In some embodiments of the present disclosure, the path planning module controls a group of UAVs U={U1, U2, . . . , Un} with n count of UAVs to perform a search task in m count of sub-regions located in a maximal search region R, the sub-regions are R1, R2, . . . , Rm, where {R1, R2, . . . , Rm}∈R.

In some embodiments, the path planning module controls the plurality of UAVs to fly at a constant altitude with respect to a scanning surface, a scanning region of one or more airborne sensors to a ground is a square with a side length d. The plurality of UAVs have a variable maximum flight time Tₘₐₓ, in a process of performing a task, the plurality of UAVs are required to return to a base station before running out of energy.

In some embodiments, the plurality of UAVs are denoted as Uᵢ=. where Tₘₐₓ denotes the maximum flight time of the ith UAV Uᵢ, Ts denotes a remaining flight time of the UAV, and E_{c} denotes an energy consumption of the UAV. In some embodiments, E_{c} denotes the energy consumption when the UAV turns.

In some embodiments, the path planning module performs a grid region decomposition on a maximum search region R based on the side length d of the scanned region of the search range of each of the plurality of UAVs. The grids are placed adjacent to each other and each cell grid region d is numbered by horizontal and vertical coordinates of its position.

In some embodiments, the numbering of each cell grid region D is determined by formula (1):

$$Number = ( {R}_{l} / d ) \times x + y \qquad ( 1 )$$

Number denotes a cell grid region number, Rₗ denotes a length of the maximum search region R, which is obtained by an actual measurement; d denotes the side length of the scanned region of the UAV; x and y respectively denote the horizontal and vertical coordinates of the position of a current cell grid region.

In some embodiments, each cell grid region has a corresponding height and a Boolean value denoted as Dₖ=<Hₖ,B>, with the Boolean value B∈{0,1}. The height value Hₖ is denotes a Z-axis coordinate of the kth cell grid region, and the Boolean value B is denoted as whether the kth cell grid region is a region of interest ROI. If the cell grid region Dk∈{R₁, R₂, . . . , Rₘ}, the Boolean value is 0, and if the cell grid region Dₖ is not within {R₁, R₂, . . . , Rₘ}, the Boolean value is 1.

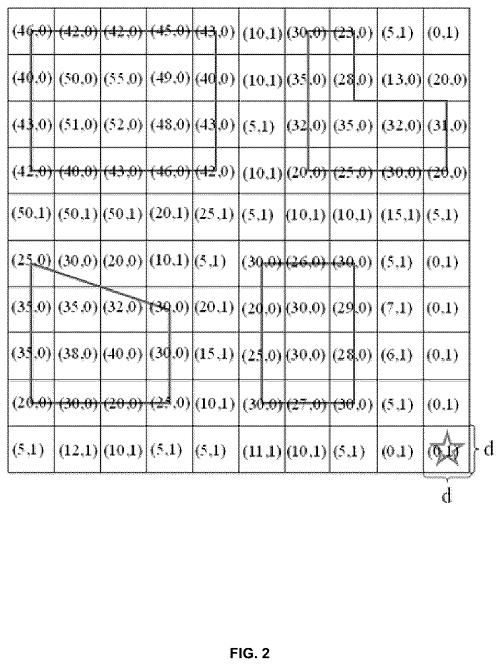

FIG. 2 is a schematic diagram illustrating a grid regionalized map for a multi-region exploration of a city according to some embodiments of the present disclosure. As shown in FIG. 2, a polygon indicates an ROI to be searched, and a region where a star is located indicates a region where a base station is located. In some embodiments, a path planning module controls a plurality of UAVs to start from the base station and return to the base station after the search is completed.

In some embodiments, the path planning module performs a 2D cell division in an overlooking view of the maximum search region R according to a scanning range of an airborne radar, each divided cell being a region that needs to be scanned once in a constant height relative to a ground height of the region. Through the above cell dividing manner, a dividing complexity of a 3D cell grid region is reduced, and a scanning efficiency is improved.

Step 2: by establishing constraints of the plurality of UAVs and an environment based on a determined 3D model of the region to be searched, a problem total cost model is established.

In some embodiments, the problem total cost model is related to a region coverage rate of each of the plurality of UAVs and an energy consumption of the plurality of UAVs.

In some embodiments, the path planning module determines a remaining flight time Tₛ by obtaining a feature label of each of the plurality of UAVs; and determines, based on the remaining flight time TS, whether a current remaining energy of the each of the plurality of UAVs is able to support flying to a next region and return to the base station. The remaining flight time refers to a duration that the UAV is still capable of flying.

Exemplarily, if the UAV Uᵢ needs to fly from a cell grid region Dₖᵢ to a cell grid region Dₖᵢ, a duration for the UAV Uᵢ to fly from the cell grid region Dₖᵢ to the cell grid region Dₖⱼ and return to the base station is subtracted from a value of the remaining flight time TS of the UAV Uᵢ to obtain a time difference. If a value of the time difference is not less than 0, the remaining energy of the UAV Uᵢ is able to support the flight to the next cell grid region and return to the base station.

In some embodiments, during a search process, the path planning module needs to continually calculate whether the remaining flight time is greater than a time required to return to the base station from a current cell grid region, and the path planning module also needs to determine, according to the foregoing manner, whether each of the plurality of UAV is able to fly to the next cell grid region and return to the base station. If the remaining flight time is not greater than the time required to return from the current cell grid region to the base station, or if the remaining flight time is not able to support the each of the plurality of UAVs to fly to the next cell grid region and return to the base station, then it is determined that the each of the plurality of UAVs is unable to continue to perform a search and rescue task, and the path planning module controls the each of the plurality of UAVs to return to the base station.

In some embodiments, constraints of the problem total cost model include at least one of a flight time constraint, a flight altitude and flight speed constraint, a scan count constraint, for the plurality of UAVs.

In some embodiments, the flight time constraint for the plurality of UAVs is also referred to as a constraint 1, the flight altitude and flight speed constraint is also referred to as a constraint 2, and a scan count constraint is also referred to as a constraint 3.

In some embodiments, the flight time constraint for the plurality of UAVs includes:

$${P}_{i} = \{ \begin{matrix}{D}_{ki} & ∀ ( {T}_{s} - {T}_{ki , kj} - {T}_{j 0} ) > 0 \\ {P}_{0} & others\end{matrix} \qquad ( 2 )$$

$$\{ \begin{matrix}{T}_{ki , kj} = {D}_{ki ( kj - num )} + {D}_{( ki + num ) ( kj - num )} + … + {D}_{( ki + num ) kj} \\ num = ⌈ {D}_{kikj} / d ⌉ \times 5\end{matrix} \qquad ( 3 )$$

Pᵢ denotes a selection of a next track point of the UAV when the UAV is in a cell grid region; P₀ denotes the base station, which is a starting track point for all the UAVs; Dₖᵢ denotes the ith cell grid region; Tₛ denotes the remaining flight time of the UAV Uᵢ; T_{ki,kj} denotes a time required for the UAV to fly from the cell grid region Dₖᵢ to the cell grid region Dₖⱼ; Tj0 denotes a time required to fly from the cell grid region Dₖⱼ to the base station.

Dₖᵢₖⱼ in the formula (3) denotes a Euclidean distance for the UAV to fly from the cell grid region Dₖᵢ to the cell grid region Dₖⱼ, and num denotes a count of sampling points obtained in a middle of the cell grid regions Dₖᵢ and Dₖⱼ.

The formula (3) indicates that from the cell grid region Dₖᵢ to the cell grid region Dₖⱼ, sampling points are taken with the side length d as a unit length, five sampling points are taken for each unit length. A first sampling point is connected to its adjacent points in turn to obtain a sampling curve with an approximate true distance, and then a sum of the Euclidean distances between the adjacent sampling points are find out to obtain the approximate true distance.

In some embodiments, the flight altitude and flight speed constraint for the UAV includes:

$$\{ \begin{matrix}{U}_{i}^{AF} = {H}_{i} + a \\ {U}_{i}^{SF} = b\end{matrix} a , b ∈ C ; i ∈ \{ 1 , 2 , … , n \} \qquad ( 4 )$$

In formula (4), Uᵢ^{SF} denotes a flight speed; Hi denotes a ground altitude of the ith UAV Uᵢ in a current region; a, b are constants, generally taken as 10 m and 1 m/s, respectively; n denotes a count of UAVs. Uᵢ^{AF} denotes a current flight altitude of the UAV Uᵢ, c is a constant sign

In some embodiments, the scan count constraint includes: scanning each cell grid region only once by one UAV, changing a Boolean value B of the cell grid region to 1 after the scanning is completed, and no other UAV is allowed to enter the region. The constraint is written as follows.

$${\sum }_{i = 1}^{n} {D}_{kl}^{i} = 1 ∀ i ∈ \{ 1 , 2 , … , n \} \qquad ( 5 )$$

Dₖᵢⁱ denotes the Boolean value of the cell grid region after scanning by all the UAVs Uᵢ, . . . , Uₙ.

In the search and rescue task, the UAV path planning may cover as much cell grid region as possible in a short flight time and minimize the energy consumption.

In some embodiments, a target function of the problem total cost model includes a surrogate value obtained by evaluating a search and rescue coverage path of each of the plurality of UAVs.

In some embodiments, the path planning module evaluates a coverage path of the search and rescue to determine the surrogate value after a UAV swarm returns to the base station after completing the task. In some embodiments, the surrogate value is a sum of a coverage rate of the ROI and a reward value for energy saving, which is expressed as the following formula (6):

$${f}_{total} = {W}_{1} {f}_{c} + {W}_{2} {f}_{t} + {W}_{3} {f}_{a} \qquad ( 6 )$$

ƒₜₒₜₐₗ denotes the target function, which is obtained by a weighted summation of a coverage rate fa. W₁, W₂, and W₃ respectively denote weight values of the coverage rate ƒ_{c}, the flight time ƒₜ, and the total turning angle cost ƒ_{α}, respectively, which are generally taken to be 0.5, 0.25, 0.25.

In some embodiments, W₁, W₂, and W₃ are also referred to as a first weight, a second weight, and a third weight.

In some embodiments, the coverage fc is determined by the following formula (7):

$${f}_{c} = \frac{{\sum }_{ki = 1}^{( \frac{{R}_{l} {R}_{w}}{{d}^{2}} )} {D}_{ki} 〈 B 〉 - {\sum }_{ki = 1}^{( \frac{{R}_{l} {R}_{w}}{{d}^{2}} )} {D}_{kl}^{′} 〈 B 〉}{( \frac{{R}_{l} {R}_{w}}{{d}^{2}} ) - {\sum }_{ki = 1}^{( \frac{{R}_{l} {R}_{w}}{{d}^{2}} )} {D}_{kl}^{′} 〈 B 〉} \times 100 \% \qquad ( 7 )$$

Rₗ and R_{w} respectively denote a length and a width of the maximum search region, Dₖᵢ<B> denotes a Boolean value B of the kith cell grid region Dₖᵢ, and Dₖᵢ′<B> denotes a Boolean value B of the kith cell grid region Dₖᵢ when the search is completed. d denotes a scanning range of the airborne sensor, a value of

$$\frac{{R}_{l} {R}_{w}}{{d}^{2}}$$

is a total count of all cell grid regions

In some embodiments, the flight time ft is determined by the following formula (8):

$${f}_{t} = T {\sum }_{k = 1}^{K} {S}_{{k}_{max}}^{d} \qquad ( 8 )$$

Tₘₐₓ denotes a maximum flight time of the UAV Uᵢ; K denotes a total track count flown at an end of the search of the current UAV Uᵢ; and Sₖ^{d} denotes a true distance of a kth step of the track, which is obtained from a start point and an end point of the kth step of the track by formula (3).

In some embodiments, the total turning angle cost fa is determined by the following formula (9):

$${f}_{a} = \frac{1}{K} {\sum }_{k = 1}^{K} {S}_{k}^{a} / π \qquad ( 9 )$$

Sₖ^{α} denotes a turning time of a kth track, and in some embodiments, the turning time is considered as a turning angle, so Sak also denotes an angle formed by the kth track and a previous track, which is derived from an angle calculation formula.

In some embodiments, the problem total cost model is: target function ƒₜₒₜₐₗ=W₁ƒ_{c}+W₂ ƒₜ+W₃ƒ_{α}; and the constraints are: constraint 1; constraint 2; constraint 3.

In some embodiments of the present disclosure, the problem total cost model constructed based on the constraints and the target function visualizes a degree of superiority of the coverage paths.

Step 3: an initial pheromone concentration is set based on a sub-region model formed by the scanning range of the airborne radar. The initial pheromone concentration is uneven, and an ant colony algorithm is utilized to solve the problem total cost model, and a preliminary planning path is obtained. The initial pheromone concentration is uneven refers to that there are different pheromone concentrations between two different cell grid regions.

In some embodiments, the initial pheromone concentration in the ant colony algorithm is a preset constant, e.g., the initial pheromone concentration is 1.

In some embodiments, the path planning module also determines the initial pheromone concentration based on a distance between the two cell grid regions. For example, the path planning module determines the initial pheromone concentration based on the distance between the two cell grid regions by formula (15), and values of the initial pheromone concentrations for paths formed by each pair of points are different, which are in an interval of (0, 1].

In the problem total cost model, the UAV constantly detects the flight time remained and allows for the flight time for returning to the base station. Therefore, there is a risk that the UAV terminates its own exploration and returns to the base station during the search and rescue process. For this reason, a count of path points the UAV passes through on each exploration path is variable. Most evolutionary algorithms are not able to optimize this kind of data with variable dimensions; whereas the ant colony algorithm is a swarm intelligence algorithm that strengthens the paths themselves, which is able to be independent from changes in the data dimensions.

In some embodiments, the path planning module optimizes a search and rescue path via the ant colony algorithm.

In some embodiments, the path planning module select and access, from the base station, the cell grid region corresponding to a next moment one by one based on ants according to a pheromone concentration and heuristic information. A solution is constructed by attempting to cover as much of the ROI as possible by seeking an optimal path with the help of a pheromone and the heuristic information using less energy consumption. The aforementioned process of the ants selecting and accessing the cell grid regions one by one is able to simulate a process of the UAVs searching the different cell grid regions in the region to be searched.

In some embodiments, the ants depart from the base station and continually select the cell grid region for the next moment by using the pheromone and a heuristic factor.

A selection probability of one cell grid region may be as follows in formula (10):

$${P}_{kikj}^{k} = \{ \begin{matrix}\frac{{{[ {τ}_{kikj} ( t ) ]}^{α} [ {η}_{kikj} ( t ) ]}^{β}}{{{{\sum }_{u ∈ allowed} [ {τ}_{kiu} ( t ) ]}^{α} [ {η}_{kiu} ( t ) ]}^{β}} & j ∈ allowed \\ 0 & others\end{matrix} \qquad ( 10 )$$

τₖᵢₖⱼ(t) denotes a pheromone concentration left by a path between a cell grid region Di to a cell grid region Dⱼ at a moment t, whose value is assigned at initialization and updated at each iteration; ηₖᵢₖⱼ(t) denotes the heuristic information from the cell grid region Di to the cell grid region Dⱼ, which is related to the distance; α and β respectively denote a pheromone factor and a heuristic factor, which reflect relative importances of the pheromone concentration and the heuristic in selecting from cell grid region Di to cell grid region Dⱼ; allowed denotes all regions that are able to be selected in the cell grid region Di, i.e., all the unscanned cell grid regions that are able to be reached and returned to the base station for a remaining voyage. τₖᵢᵤ(t), ηₖᵢᵤ(t) denote the pheromone concentration and the heuristic information from the cell grid region Di to the cell grid region Dᵤ, respectively.

In some embodiments, the heuristic information is expressed as the following formula (11)

$${η}_{kikj} = 1 / {d}_{kikj} \qquad ( 11 )$$

wherein dₖᵢₖⱼ denotes a distance from the cell grid region Dᵢ to the cell grid region Dⱼ.

In some embodiments, in response to determining that the ants complete a task and return to the base station and an iterative search ends, the pheromone between the cell grid regions is updated based on a result of the iterative search.

In some embodiments, the pheromone concentration of the current path is updated based on a degree of superiority of the current path that the ants are traveling through, and the pheromone concentration decreases over time.

In some embodiments, the path planning module updates the pheromone concentration according to the following formula (12) and formula (13):

$${τ}_{kikj}^{am} ( t + 1 ) = ( 1 - ρ ) {τ}_{kikj}^{am} ( t ) + {\sum }_{am = 1}^{AM} Δ {τ}_{kikj}^{am} ( t ) \qquad ( 12 )$$

$$Δ {T}_{kikj}^{am} ( t ) = \{ \begin{matrix}\frac{Q}{{L}_{reward}} & if the amth ant flies from region {D}_{ki} to {D}_{kj} \\ 0 & other situations\end{matrix} ; \qquad ( 13 )$$

wherein ρ denotes a global pheromone volatilization factor with a value of (0,1); τₖᵢₖⱼ^{am}(t) denotes the pheromone concentration of a path traveled by the amth ant at a moment t; Δ_{T}_{ₖᵢₖⱼ}_{^{am}}(t) denotes a change in the pheromone concentration of the amth ant on a path from the cell grid region Dₖᵢ to the cell grid region Dₖⱼ at the moment t; and Q is a pheromone updating intensity factor constant; L_{reward} denotes a degree of superiority of the path from the cell grid region Dₖᵢ to the cell grid region Dₖⱼ, which is taken as an inverse of the target function in the present disclosure. AM denotes a total count of ants, and τₖᵢₖⱼ^{am}(t+1) denotes a pheromone concentration of a path traveled by the amth ant in a next moment of the moment t.

The ant colony algorithm has a powerful exploration ability, and a result of the degree of superiority in an initial generation of exploration has a greater fluctuation. By performing further optimization according to a value of the target function of each path, better paths may be achieved through iteration.

Step 4: based on the preliminary planning path obtained in step 3, whether a count of iterations is greater than 1 is determined, in response to determining that the count of iterations is greater than 1, the pheromone is augmented using an elite strategy while adaptively adjusting the heuristic factor with Q-learning; in response to determining that the count of iterations is not greater than 1, the pheromone is augmented using the elite strategy.

The elite strategy refers to a retaining good solution to positively influence an entire searching process of the ant colony algorithm. These good solutions are called elite solutions or global best solutions, which are the optimal or approximate optimal solutions found during the searching process.

In some embodiments, the elite strategy is introduced during a pheromone updating phase. Exemplarily, the pheromone is updated by the elite solution after the ant completes the path.

In some embodiments, to avoid an over-reliance on the elite solution, which leads to the algorithm falling into a local optimum, the elite solution is set to ¼ of a population size.

In some embodiments, the path planning module updates the pheromone of the ant colony based on the elite solution by the following formula (14):

$${T}_{kikj}^{am} ( t + 1 ) = ( 1 - ρ ) {T}_{kikj}^{am} ( t ) + 4 \times {\sum }_{am = 1}^{AM} Δ {T}_{kikj}^{am} ( t ) \qquad ( 14 )$$

As the elite strategy eliminates poorly-performing solutions, a probability for the next generation of individuals to explore a better solution is increased, thereby improving a speed of convergence and a search efficiency of the ant colony algorithm. By retaining good solutions, the elite strategy helps the algorithm to find high-quality solutions in a search space faster, and positively affects a global search capability of the algorithm.

To improve a performance of the ant colony algorithm, an uneven pheromone strategy is proposed in some embodiments of the present disclosure. For example, in an early stage of the search, the ants pay more attention to global information; while in a later stage of the search, the ants rely more on local information.

In some embodiments, the path planning module adjusts the initial pheromone concentration when initializing the pheromone based on distances between the path points, thereby enabling the ant colony to explore more regions at the early stage with a lower cost.

In some embodiments, the path planning module determines the initial pheromone concentration by the following formula (15):

$${τ}_{kikj}^{0} = 1 / {T}_{kikj} \qquad ( 15 )$$

τ⁰ₖᵢₖⱼ denotes an initial pheromone concentration from the cell grid region Dₖᵢ to the cell grid region Dₖⱼ, and Tₖᵢₖⱼ denotes a true distance between the cell grid region Dₖᵢ to the cell grid region Dₖⱼ, which is obtained from the formula (3).

In some embodiments, an adaptive strategy based on Q-learning is proposed to optimize the heuristic factor in the ant colony algorithm, which results in a better exploration ability in the early stage and a better convergence ability in the later stage.

In some embodiments, the path planning module adaptively adjusts the heuristic factor based on the processing of two stages.

In some embodiments, a first stage processing includes: performing a path planning for an initial population using the ant colony algorithm, recording the coverage rate, the energy consumption, and a time remaining reward when initializing; and generating a Q table with 3-rows and 3-column that all initial data is 0 after updating the pheromone based on the initial pheromone concentration, and randomly selecting one group of states therefrom.

In some embodiments, a second stage processing includes: starting from a second generation, dividing the population into three sub-populations, one population corresponds to one action in the q table, and determining a current moment state based on a relationship between magnitudes of the coverage rates fc and magnitudes of the energy consumptions fa of the current moment and a previous moment; determining a target movement based on the current moment state and a Q value; and dynamically and adaptively adjusting a parameter size of the heuristic factor based on the target action, so as to achieve a better ability for exploration and convergence.

In some embodiments of the present disclosure, a Q-learning is performed on the heuristic factor to enable an adaptive adjustment when facing different states. Initial Q values are shown in Table 1.

TABLE 1
Table of Initial Q Values

| | action | | |
|---|---|---|---|
| S(t) | β = β + Δβ | β = β − Δβ | β = β |
| c_{g}^{t} < c_{g}^{t-1} | 0 | 0 | 0 |
| c_{g}^{t} = c_{g}^{t-1} | 0 | 0 | 0 |
| c_{g}^{t} > c_{g}^{t-1} | 0 | 0 | 0 |

In the table, S(t) denotes a state of a population of current generation; c_{g}^{t}=f_{c}+fₐ denotes a total cost at the moment t; c_{g-1}^{t} denotes a total cost of a previous generation g−1. β denotes the heuristic factor, and Δβ denotes a denotes a changing difference of the heuristic factor, which is set to 0.1.

In some embodiments, in response to completing initialization, in the second generation, divide the population into three sub-populations with a same size, wherein the three sub-populations operate in parallel, one sub-population corresponds to one action, and different sub-populations adopts different heuristic factors, the heuristic factors are respectively β+Δβm, β−Δβ, and β. After the completion of one generation of path planning, determine the Q values corresponding to each of the three actions, and update the Q table.

In some embodiments, the first sub-population selection strategy is calculated by the following formula (16):

$${P}_{kikj}^{k} ( t ) = \{ \begin{matrix}\frac{{{[ {τ}_{kikj} ( t ) ]}^{α} [ {η}_{kikj} ( t ) ]}^{β + Δ β}}{{{{\sum }_{u ∈ allowed} [ {τ}_{kiku} ( t ) ]}^{α} [ {η}_{kiku} ( t ) ]}^{β + Δ β}} & kj ∈ allowed \\ 0 & others\end{matrix} \qquad ( 16 )$$

In some embodiments, a second sub-population selection strategy and a third sub-population selection strategy are calculated in the same way as the first sub-population selection strategy, which uses respective corresponding heuristic factor, wherein Pₖᵢₖⱼ^{k}(t) denotes a selection probability of each region at a moment t.

In some embodiments, a Q value update strategy is calculated by the following formula (17):

$$Q ( {S}_{g} , {A}_{g} ) = Q ( {S}_{g} , {A}_{g} ) + φ ( {R}_{g + 1} + λ {max}_{a} Q ( {S}_{g + 1} , a ) - Q ( {S}_{g} , {A}_{g} ) ) \qquad ( 17 )$$

Q(S_{g}, A_{g}) denotes a Q value corresponding to an action A_{g} of state S_{g} in generation g;

$${max}_{a} Q ( {S}_{g + 1} , a )$$

denotes a maximum Q value among all the actions in generation g+1; R_{g+1} denotes a reward value corresponding to generation g+1, and denotes a mean value of the target function fₜₒₜₐₗ of the sub-populations; φ denotes a learning rate of historical information; and λ denotes an estimated value of a future expectation, which takes value in a range of [0,1]. The Q value update is for the next iteration to select an action based on the new Q value, which is no longer used in this iteration.

Step 5: a reward value of each ant colony is calculated, and whether a maximum iteration count is reached is determined, in response to determining that the maximum iteration count is reached, returning to step 3, and in response to determining that the maximum iteration count is reached, a path corresponding to a current round of iteration is determined as a final path.

In some embodiments, at an end of each iteration, a reward value of each individual in the current iteration is recorded, the value of which is the fₜₒₜₐₗ value of the problem total cost model established in step 2. The reward value is used to determine a superiority of each individual, and then the elite strategy is used to eliminate poorly performing individuals.

In some embodiments, when a count of iterations reaches the maximum value, the optimal path in the population in this generation is output, and if a count of iterations does not reach the maximum value, the value of the heuristic factor adjusted adaptively according to the Q-learning in step 4 is substituted into step 3 and proceed to the next iteration. The optimal path is determined based on the latest Q value table corresponding to the ant with the greatest reward value in the population of this generation. For example, the path planning module selects, based on the ants, an action with the greatest Q value from the base station and moves to the next state, then selects the action with the greatest Q value again and moves, and repeats the process until reaching an endpoint. The path passed by the ants during this process is the optimal path.

Some embodiments of the present disclosure provide a device for UAV static track planning. The device includes a processor, a memory, and a computer program stored in the memory, which is able to run on the processor. The processor implements, when executing the computer program, the aforementioned steps of a method for UAV static track planning. In some embodiments, the method for UAV static track planning is also referred to as a method for UAV collaborative coverage path planning based on a Q-learning adaptive ant colony algorithm.

In some embodiments, the planning methods of some embodiments of the present disclosure are comparatively analyzed with planning methods based on other algorithms by independent experiments. The process includes:

Generating a multi-ROI map based on an urban rescue environment, with heights of buildings set according to formula (18):

$${H}_{ck} ( x , y ) = {h}_{ck} \times exp ( \frac{{( {x}_{ck}^{cen} - x )}^{2}}{{s}_{ck}^{x}} + \frac{{( {y}_{ck}^{cen} - y )}^{2}}{{s}_{ck}^{y}} ) \qquad ( 18 )$$

H_{ck}(x, y) denotes a height corresponding to a ckth building at horizontal coordinates of (x, y), each horizontal coordinate corresponds to a height value. s_{ck}^{x}, and s_{ck}^{y} denote a changing magnitude of the ckth building from a center of the building along an x-axis direction and a y-axis direction, which are used to simulate a collapse trend of the ckth building. xₖ^{cen} and yₖ^{cen} denote the x-axis and the y-axis coordinates where a center point of the ckth building is located. hck denotes a height of the highest point of the ckth building.

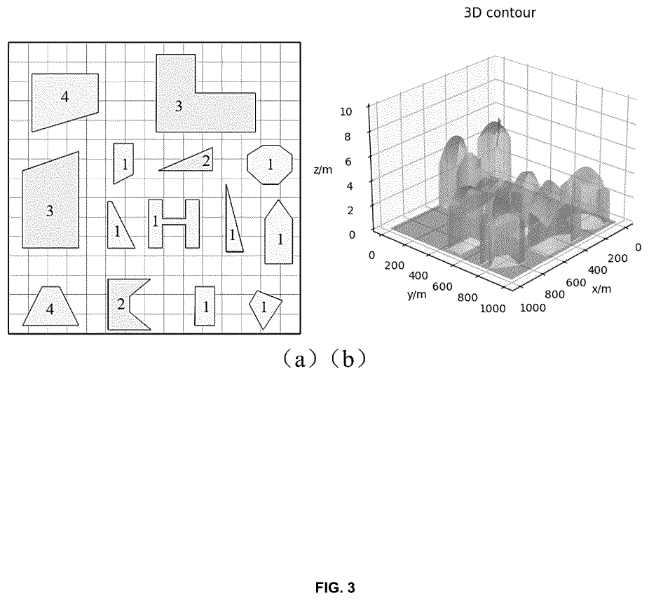

FIG. 3 is a model diagram illustrating an urban multi-region environment according to some embodiments of the present disclosure.

As shown in FIG. 3, regions marked with a same number in the figure represents an ROI. The regions marked with number 1 in a left figure (a) constitute a map model that includes 8 regions, the regions marked with number 2 and the regions marked with number 3 constitute a map model that includes 10 regions, the regions marked with number 1, 2, and 3 constitute a map model that includes 12 regions, and the regions marked with number 1, 2, 3, and 4 constitute a map model that includes 14 regions. The figure on the right shows a 3D map in a multi-region environment. Figure (b) on the right shows a distribution and a region height of a simulation map.

In some embodiments, reward values of a plurality of UAVs when there are 8/10/12/14 regions are obtained based on track information.

Table 2 shows the respective reward value corresponding to different algorithms using different counts of UAVs when there are 8/10/12/14 regions. As shown in Table 2, UAV indicates unmanned aerial vehicle, ACO indicates path planning using a basic ant colony algorithm, ACS indicates the basic ant colony algorithm plus an elite strategy, ACS+adaptive indicates adding linear adaptive strategy based on the ACS, ACS+adaptive+uneven pheromone indicates adding initial uneven pheromone concentration strategy based on the ACS+adaptive, and ACS+RL adaptive+uneven pheromone indicates an adaptive strategy formed by replacing the linear adaptive strategy by a reinforcement learning (RL) based adaptive strategy proposed in the present disclosure.

As can be seen from Table 2, the reward values obtained by the method proposed by the present disclosure are all greater than those of the other algorithms in a case of retaining three valid digits after a decimal point. It can be concluded that when the count of regions is the same, the method proposed in the present disclosure outperforms the other algorithms in satisfying the constraints, which helps to find paths with lower track costs.

TABLE 2
Comparison of results when there are 2/3/4 UAVs

| | | | | | ACS + |
|---|---|---|---|---|---|
| | | | | | adaptive, |
| | | | | | and |
| | | | | | ACS + |
| | | | | ACS + | RL |
| | | | | adaptive + | adaptive + |
| | | | | uneven | uneven |
| | | | ACS + | pher- | pher- |
| | ACO | ACS | adaptive | omone | omone |
| UAV count\ | | | | | |
| Region count: 8 | | | | | |
| 2 | 264.601 | 274.937 | 277.076 | 280.702 | 285.934 |
| 3 | 398.457 | 403.001 | 406.084 | 406.4 | 409.512 |
| 4 | 516.997 | 521.157 | 526.001 | 526.331 | 532.129 |
| UAV count\ | | | | | |
| Region count: 10 | | | | | |
| 2 | 248.258 | 255.806 | 261.599 | 262.975 | 266.981 |
| 3 | 379.248 | 390.007 | 394.368 | 399.255 | 403.506 |
| 4 | 492.253 | 516.787 | 523.077 | 526.23 | 530.936 |
| UAV count\ | | | | | |
| Region count: 12 | | | | | |
| 2 | 222.264 | 225.473 | 231.006 | 232.113 | 233.391 |
| 3 | 307.864 | 328.98 | 331.967 | 333.7 | 335.169 |
| 4 | 434.542 | 441.702 | 442.457 | 449.581 | 450.201 |
| UAV count\ | | | | | |
| Region count: 14 | | | | | |
| 2 | 203.184 | 216.262 | 216.503 | 223.886 | 229.047 |
| 3 | 297.197 | 318.95 | 320.624 | 324.254 | 329.305 |
| 4 | 396.043 | 412.963 | 415.65 | 416.305 | 429.174 |

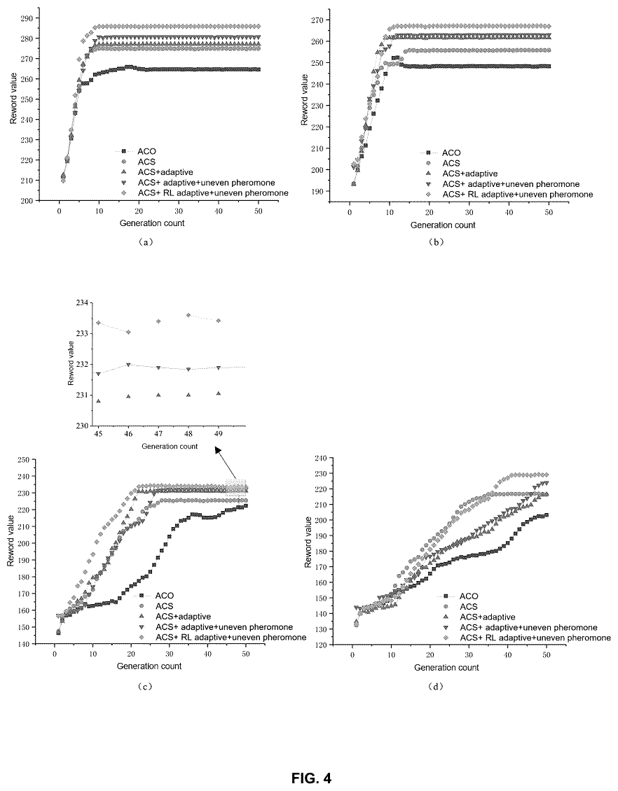

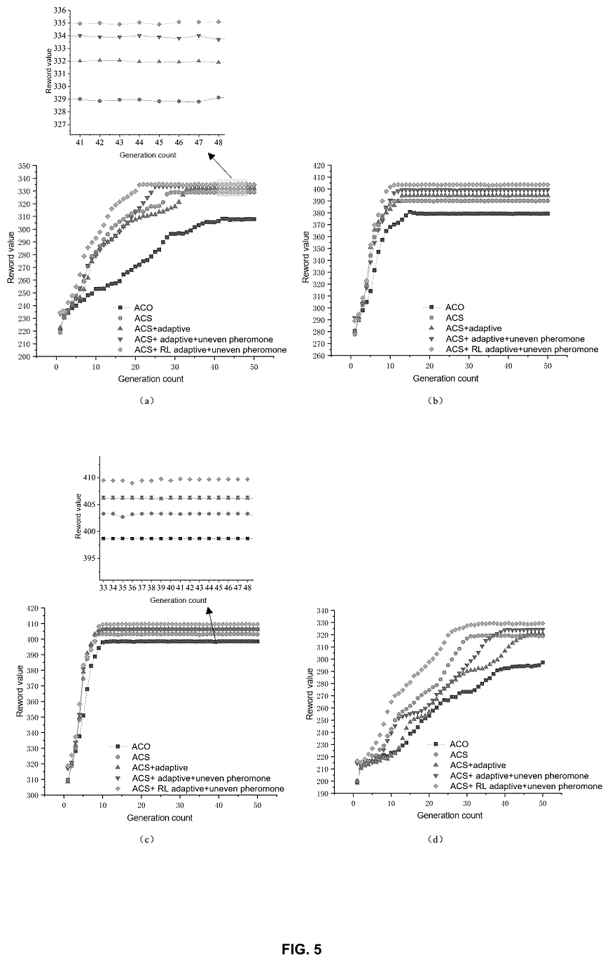

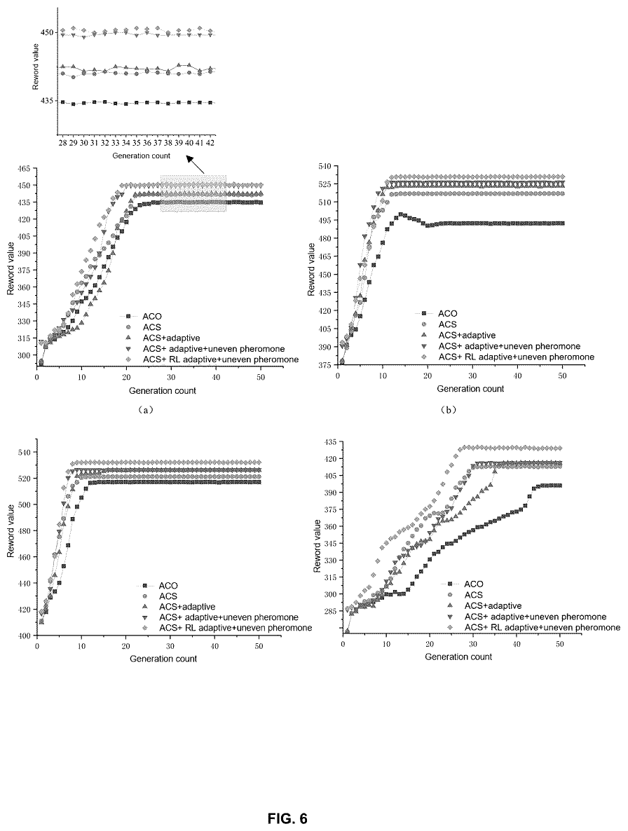

FIG. 4 is a schematic diagram illustrating a comparison of iterative reward values when there are two UAVs according to some embodiments of the present disclosure; FIG. 5 is a schematic diagram illustrating a comparison of iterative reward values when there are three UAVs according to some embodiments of the present disclosure; FIG. 6 is a schematic diagram illustrating a comparison of iterative reward values when there are four UAVs according to some embodiments of the present disclosure.

As shown in FIGS. 4-6, (a) shows a reward value per generation for each algorithm when there are 8 regions, (b) shows the reward value per generation for each algorithm when there are 10 regions, (c) shows the reward value per generation for each algorithm when there are 12 regions, and (d) shows the reward value per generation for each algorithm when there are 14 regions.

From FIGS. 4-6, it may be seen that when there are 8 regions, the map is simple and there are fewer sub-regions to be scanned, and energy constraints of a UAV swarm are able to support the plurality of UAVs to scan the sub-ROI completely, and there is little difference on performances of the algorithms. When there are 10 regions, the map becomes more complex, and a reasonable planning effectively saves an energy consumed by the plurality of UAVs during flight, so an improved strategy introduced shows some performance advantages.

When there are more regions, sizes of the sub-regions divided by the map according to a radar detection range of the UAV change from 10*10 to 15*15, which poses a harder test on a planning ability of the algorithm. For example, when there are 12 and 14 regions, the UAVs are unable to completely cover the ROIs during their flight times, and compared to an unimproved strategy, the improvement strategy shows a faster convergence ability when the sub-ROIs are unable to be completely covered. faster convergence ability.

In addition, when there are a great number of regions, it may be seen that traditional adaptive methods have a weak convergence ability in solving the problem, while the Q-learning based adaptive strategy solves a problem of slow convergence of the traditional adaptive and has a better performance.

It may be deduced that the improved algorithm shows a stronger exploration ability when the energy of the UAV is sufficient. The improved algorithm is able to autonomously regulate an exploration efficiency and find a global optimum for convergence. When the UAV has insufficient energy to explore all the sub-regions, the improved algorithm shows a stronger convergence ability, which tends to find a current optimal solution and converge.

In FIGS. 4-6, five algorithms under a condition with the same number of UAVs and the same number of regions are comparatively investigated. A description of the five algorithms may be found above.

Based on an analysis of FIGS. 4-6, it may be concluded that the present disclosure performs well in a convergence stage, and is able to quickly find better performing solutions and reach a steady state. An increase in a convergence speed is very important for practical applications, as it means that more reliable and stable results may be obtained in a limited time period. In some embodiments of the present disclosure, performing path planning by the ant colony algorithm helps to efficiently converge to an optimal solution or an approximately optimal solution during the convergence process, which provides a highly efficient way to solve the problem.

In some embodiments of the present disclosure, the ant colony algorithm enables the path planning to converge quickly in the convergence phase, which has a better performance, and the ant colony algorithm further provides a more reliable and efficient solution for solving the path planning problem, which has an important value in practical applications, and helps to discover better solutions or innovative solutions.

In some embodiments of the present disclosure, a Q-learning based adaptive ant colony algorithm is used: an initial population is divided into a plurality of groups, and a different heuristic factor is applied to each population to improve the explore capability of the algorithm; an uneven pheromone is introduced at an initial pheromone, to make it easier to search for better-performing solutions in an early stage. At the same time, an elite strategy is used to eliminate poorer solutions when updating the pheromone. At an end of each generation, the heuristic factor of the ant colony algorithm is adaptively adjusted by using the Q-learning to enable the algorithm to autonomously focus on both local and global searches throughout the optimization process, and to adaptively adjust a convergence speed, resulting in better results when performing path planning for the UAV.

FIG. 7 is a schematic diagram illustrating a multi-UAV cooperative coverage system for path planning based on an improved ant colony algorithm with a Q-learning adaptive strategy according to some embodiments of the present disclosure. As shown in FIG. 7, a system for multi-UAV collaborative coverage path planning based on a Q-learning adaptive ant colony algorithm 700 (hereinafter referred to as “system for path planning 700” or “system for path planning”) includes a memory 710, an image collection device 720, and a plurality of UAVs 730.

In some embodiments, the memory 710 is configured as at least one type of data generated during an operation of the system for path planning. For example, a first preset program, a second preset program, a third preset program, an environmental image, a weight prediction model, etc.

In some embodiments, the memory 710 includes one or more storage components, each of which being an independent device or being a part of other devices. Exemplarily, the memory 710 includes a cloud storage, or other devices that are used for a data storage.

In some embodiments, the memory 710 is communicatively connected to the image collection device 720 and the plurality of UAVs 730. For example, the memory 710 exchanges data and/or information with the image collection device 720, the plurality of UAVs 730, or other portions outside the system for path planning over a network.

In some embodiments, the image collection device 720 is configured to collect an environmental image of a region to be searched and store the environmental image to the memory 710.

In some embodiments, the image collection device 720 includes one or more image collection devices. Exemplarily, the image collection device includes a camera, an infrared camera, or other device capable of collecting the environmental image.

In some embodiments, the plurality of UAVs 730 are configured to perform a path planning and search the region to be searched based on the planned path.

In some embodiments, each of the plurality of UAVs 730 includes a processor. The processor is configured to process the data and/or information from the memory 710 or the image collection device 720, and control the UAV 730 to execute program instructions based on the foregoing data, information, and/or processing results to perform one or more functions described in some embodiments of the present disclosure.

In some embodiments, the processor of the UAV is loaded with a path planning module 740.

In some embodiments, the path planning module 740 is configured to construct a 3D model in a collaborative coverage environment based on the environmental image through a first preset program obtained from the memory, obtain information of a region to be searched from the memory, and by performing a cell division on the 3D model based on a scanning range of an airborne radar of each of the plurality of UAVs, obtain one or more sub-regions.

The environmental image refers to an image reflecting an overall condition of the region to be searched. In some embodiments, the path planning module communicates with the image collection device 720 to obtain one or more environmental images collected by the image collection device 720.

The first preset program refers to a program for determining the 3D model corresponding to the region to be searched.

In some embodiments, the first preset program is a 3D modeling program.

In some embodiments, the path planning module 740 constructs a 3D model in a cooperative coverage environment based on the one or more environmental images via the first preset program. For example, the one or more of the environmental images are input to the first preset program to obtain the 3D model of the region to be searched output by the first preset program.

In some embodiments, the path planning module 740 processes the one or more environmental images to extract an information density of the region to be searched; calls a corresponding 3D modeling program from the memory 710 based on the information density and an area of the region to be searched; and, through the 3D modeling program, determines a model accuracy based on the information density and the area of the region to be searched, and constructs the 3D model based on the model accuracy.

The information density refers to a denseness of the information in the region to be searched, and is used to reflect an environmental complexity of the region to be searched. The higher the information density of the region to be searched, the higher the environmental complexity of the region to be searched corresponding to the environmental image.

In some embodiments, the path planning module 740 processes the one or more environmental images corresponding to the region to be searched, extracts the information density of the region to be searched based on a result of the processing. For example, the path planning module 740 divides each environmental image based on pixels, determines a category of each pixel point in each environmental image, counts a category count of the pixel points in each environmental image, and determines, based on an average value of the category count of the pixel points in each environmental image, an information density of the region to be searched, and the greater the aforementioned average value, the higher the information density of the region to be searched.

The category of the pixel point refers to a type of an object to which the pixel point belongs. For example, the category of the pixel point includes, but is not limited to, a ground, a building, the sky, a person, a vegetation, etc., which is determined based on an actual situation of the environmental image.

In some embodiments, at least one 3D modeling program and its corresponding index tag are stored in the memory 170. The index tag is used to indicate the environment to which the 3D modeling program applies, which is represented as a vector, and elements in the vector include a reference information density and a reference area.

In some embodiments, the path planning module 740 constructs a region feature vector based on the information density and the area of the region to be searched, conducts a search in the memory 170 based on the area feature vector, determines an index tag with the highest similarity to the aforementioned information density and the area, and calls the 3D modeling program corresponding to the index tag. The similarity is determined based on a vector distance between the region feature vector and the index tag.

The model accuracy refers to data that reflects how accurately the 3D model simulates the actual environment. The higher the model accuracy, the more accurate the corresponding 3D model is in simulating the actual environment. The aforementioned accuracy is reflected in terms of a geometry shape, a surface smoothness and a degree of consistency with the actual environment.

In some embodiments, the model accuracy is correlated with the information density and the area of the region to be searched. Exemplarily, the higher the information density of the region to be searched, the higher the model accuracy is required to ensure the accurate simulation of the actual environment; the greater the area of the region to be searched, the lower the model accuracy is selected to ensure an efficiency of the 3D modeling.

In some embodiments, the path planning module 740 determines the model accuracy based on the information density and area of the region to be searched through a 3D modeling procedure by means of a cluster analysis.

In some embodiments, the path planning module 740 determines at least one first reference vector and its corresponding first label based on historical data. Elements in the first reference vector include a historical information density and a historical area of a historical region to be searched, and the corresponding first label thereof is a historical model accuracy corresponding to the historical information density and the historical area.

In some embodiments, the path planning module 740 determines the region feature vector of the region to be searched and at least one first reference vector as a first clustering object, clusters the first clustering object based on a first clustering indicator, obtains a plurality of clusters, and take the cluster where the region feature vector is located as a first target cluster. The path planning module 740 takes the first label corresponding to the first reference vector in the first target cluster that satisfies a selection condition as the model accuracy. The first clustering indicator may be the information density and the area of the region to be searched.

In some embodiments, the selection condition may be that the reference vector corresponds to the least evaluation value.

The evaluation value is used to reflect an efficiency of a historical path planning operation corresponding to the reference vector, the smaller the evaluation value, the higher the efficiency.

In some embodiments, the evaluation value is determined based on a weighted sum of a historical target function and a total path-planning time corresponding to a historical UAV swarm in the historical path-planning operation corresponding to the reference vector. A weight of the weighting is set based on prior experience and/or actual needs.

In some embodiments, the path planning module 740 constructs the 3D model corresponding to the region to be searched according to the modeling accuracy by means of the 3D modeling program.

In some embodiments of the present disclosure, determining a suitable model accuracy and the 3D modeling program by the information density and the area of an environment to be searched helps to better balancing the accuracy and the efficiency of the construction of the 3D model, and to more efficiently construct a 3D model satisfying the requirement.

In some embodiments, the path planning module 740 also determines constraints for the plurality of UAVs and the environment based on the 3D model of the region to be searched to establish a problem total cost model.

Detailed descriptions on determining the constraints of the plurality of UAVs and the environment, and constructing the problem total cost model may be found in the relevant descriptions in Step 2 of FIG. 1 of the present disclosure.

In some embodiments, the path planning module also performs a plurality of rounds of iterations. Each round of iteration includes: setting an initial pheromone concentration based on the one or more sub-regions formed by the scanning range of the airborne radar, by solving the problem total cost model using a second preset program obtained from the memory 710, obtaining a preliminary planning path; determining whether a count of iterations is greater than 1, in response to determining that the count of iterations is greater than 1, augmenting a pheromone using an elite strategy while adaptively adjusting a heuristic factor with a third preset program obtained from the memory; in response to determining that the count of iterations is not greater than 1, augmenting the pheromone using the elite strategy.

The second preset program is an algorithmic program for solving the problem total cost model. In some embodiments, the second preset program is an ant colony algorithm, or other models or algorithms used to solve the problem total cost model.

The third preset program is an algorithmic program for adjusting the heuristic factor. In some embodiments, the third program is a Q-learning algorithm, or other models or algorithms used to adjust the heuristic factor.

Detailed descriptions of the multi-round iteration, the ant colony algorithm, and Q-learning algorithm may be found in the relevant descriptions in Steps 3 and 4 of FIG. 1 of the present disclosure.

In some embodiments, the path planning module 740 also obtains the information density of the sub-region; and adjusts an initial pheromone concentration in the sub-region based on the information density.

In some embodiments, the path planning module 740 determines the information density of the sub-region based on the categories of pixel points in the sub-region. The process of determining the information density of the sub-region is similar to the process of determining the information density of the region to be searched, as can be seen in the previous related descriptions.

In some embodiments, the path planning module 740 adjusts the initial pheromone concentration of one or more sub-regions based on a difference between the information density of the sub-region and the information density of the region to be searched. For example, the path planning module determines an adjusted initial pheromone concentration according to the following formula (19).

$${τ}^{′} = ( 1 + \frac{Δ τ}{{ρ}_{im}} ) * {τ}_{0}$$

τ′ denotes the adjusted initial pheromone concentration; Δτ denotes the difference between the information density of the sub-region and the information density of the region to be searched; ρᵢₘ denotes the information density of the region to be searched; and τ₀ denotes the initial pheromone concentration of the sub-region.

In some embodiments, the path planning module 740 also calculates a reward value of each ant colony and determines whether a maximum iteration count is reached, in response to determining that the maximum iteration count is reached, enters a new round of iteration, in response to determining that the maximum iteration count is reached, outputs a path corresponding to a current round of iteration as a final path. More details may be found in the descriptions in Step 5 of FIG. 1 of the present disclosure.

In some embodiments, the path planning module 740 determines both an outlier risk point and a collision risk point for one or more UAVs, and control the UAVs when the one or more UAVs reach the outlier risk point and/or the collision risk point.

In some embodiments, the path planning module 740 further determines the outlier risk point and the collision risk point when the plurality of UAVs are traveling on the final path based on the final path; in response to determining that the plurality of UAVs reach the outlier risk point, determines a communication frequency and controls the plurality of UAVs to communicate with a control center based on the communication frequency; and determines an acceleration threshold of the plurality of UAVs, and in response to determining that an acceleration of the plurality of UAVs approaches a warning value, controls the plurality of UAVs to lock a power valve and/or adjusts a propeller attitude, so as to limit the acceleration of the plurality of UAVs.

The outlier risk point refers to a plurality of time points at which a probability of the UAV deviating from the final path is higher than an outlier probability threshold; and the collision risk point refers to a plurality of time points at which a probability of the UAV colliding with other objects is higher than a collision probability threshold. The outlier probability threshold and the collision probability threshold may be determined based on a priori experience.

In some embodiments, the path planning module 740 performs a plurality of simulations on the process of the plurality of UAVs traveling along the final path based on simulation software, and determines the outlier risk points and the collision risk points of the plurality of UAVs based on a result of the simulations. For example, if, in the plurality of simulations, a ratio of a count of times that the plurality of UAVs undergo a route deviation or undergo a collision at point A to a total count of simulations exceeds a preset ratio, the point A is determined to be the outlier risk point or the collision risk point. The preset ratio is determined based on the priori experience.

In some embodiments, the count of simulations is positively correlated with the count of iterations experienced in determining the final path.

In some embodiments, in response to the plurality of UAVs arriving at the outlier risk point, the path planning module 740 increases a current communication frequency of the plurality of UAVs by a preset value to better ensure that the positions of the plurality of UAVs are updated timely, so that when the traveling paths of the plurality of UAVs are deviated, the deviation is discovered timely. The preset value is set based on the priori experience.

In some embodiments, the path planning module 740 determines the acceleration of the plurality of UAVs by reading traveling data of the plurality of UAVs and analyzing it. In response to determining that an acceleration of the plurality of UAVs is not less than the warning value, the path planning module 740 controls the plurality of UAVs to lock a power valve and/or adjust a propeller attitude, so as to limit the acceleration of the plurality of UAVs.

The warning value refers to the maximum acceleration that is acceptable during the travel of the UAV. In some embodiments, the warning value is determined based on a variety of manners. For example, the warning value is set based on the priori experience. For another example, the warning value is determined based on a distance distribution of the plurality of UAVs, e.g., the smaller an average distance between the individual UAV in the plurality of UAVs, the smaller the warning value.

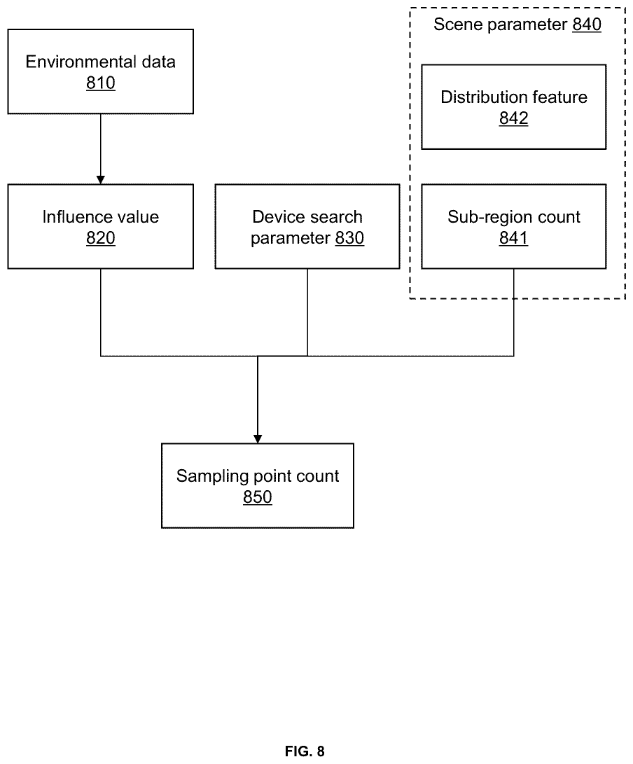

FIG. 8 is a schematic diagram illustrating a process of determining a sampling point count according to some embodiments of the present disclosure. As shown in FIG. 8, a process of determining the sampling point count may include the following contents. In some embodiments, the process of determining the sampling point count is performed by the path planning module 740.

An evenness of the environment affects a search process of a plurality of UAVs. For example, if the evenness of the environment in a region to be searched is high, and a difference degree of an environment seen at different point positions is smaller, the search is performed according to a lower sampling granularity to ensure an efficiency of the search; if the evenness of the environment in the region to be searched is low, and the difference degree of the environment seen at different point locations is greater, the search needs to be performed according to a higher sampling granularity to obtain more comprehensive information. Therefore, it is necessary to consider an influence of environmental factors on the plurality of UAVs when determining the sampling point count in the process of path planning.

In some embodiments, each of the plurality of UAVs 730 is further loaded with an environmental sensor module. The environmental sensor module is configured to obtain environmental data in a region to be searched.

In some embodiments, the path planning module also determines, based on environmental data 810, an impact value 820 of the current environment of the region to be searched on the travel path of each of the plurality of UAVs; and determines the sampling point count 850 based on an influence value 820, a device search parameter 830, and a scene parameter 840 of the UAV.

The environmental data refers to data that reflects features of the environment. Exemplarily, the environmental data includes, but is not limited to, at least one of a temperature, a humidity, a wind speed, and a wind direction, which is determined based on actual needs.

In some embodiments, the environmental data indicates a current environment feature at a point position where the UAV is located in the region to be searched.

In some embodiments, the path planning module 740 obtains the environmental data via an environmental sensor module.

In some embodiments, the environmental sensor module includes a variety of environmental sensors. For example, the environmental sensors include, but are not limited to, at least one of a temperature sensor, a humidity sensor, and a wind speed and wind direction sensor, and are loaded according to actual needs.

The influence value reflects how much the current environment in the region to be searched affects the traveling path of each of the plurality of UAVs. The higher the influence value, the greater the influence of the current environment on the travel path of each of the plurality of UAVs.

In some embodiments, the path planning module 740 determines, based on the environmental data, the influence value of the current environment on the traveling path of each of the plurality of UAVs through a cluster analysis.

In some embodiments, the path planning module 740 constructs an environmental feature vector based on the environmental data collected by each of the plurality of UAVs. The environmental feature vector includes the environmental data for at least one point position collected by one UAV, and an element of the environmental feature vector corresponds to the environmental data for one point position.

In some embodiments, the path planning module 740 determines at least one second reference vector and its corresponding second label based on historical data. Elements in the second reference vector include, in the historical data, historical environmental data collected by a historical UAV, and corresponding second labels thereof are a historical influence value of the actual traveling path and the planned traveling path of the historical UAV when it performs a search task. In some embodiments, this historical influence value is represented by a historical deviation value of the traveling path of each of the plurality of UAVs, and the greater the historical deviation value, the greater the historical influence value.

In some embodiments, the historical deviation value is determined based on a difference between the actual traveling path and the planned traveling path of the historical UAV. Exemplarily, the path planning module 740 selects at least one critical planning point on the planned traveling path and obtains an actual point on the actual traveling path that corresponds to the at least one critical point, determines a tangent line of the at least one critical planning point and a tangent line of its corresponding actual point, and uses an average value of an angular difference value corresponding to the at least one critical planning point as the historical deviation value.

In some embodiments, the path planning module 740 determines the environment feature vector and the at least one second reference vector as a second clustering object, clusters the second clustering object based on a second clustering indicator, to obtain a plurality of clusters, and takes the clusters where the environmental feature vectors are located as a second target cluster. The path planning module 740 takes an average value of the second labels corresponding to each of the second reference vectors in the second target cluster as the influence value of the current environment on the traveling path of each of the plurality of UAVs.

The device search parameter 830 refers to a parameter that indicates a UAV feature in the search task. For example, the device search parameter includes at least one of a UAV count, a side length of a scanning region of a search range of each of the plurality of UAVs, at least one of a flight speed and a flight altitude of the each of the plurality of UAVs, and also includes other parameters indicating the features of the plurality of UAVs, which are determined based on the actual needs.

The scene parameter 840 refers to a parameter indicating a level of granularity of the division of the region to be searched. In some embodiments, the scene parameter 840 includes a sub-region count 841.

In some embodiments, the scene parameter 840 further includes a distribution feature 842 of an ROI. The ROI refers to a region that needs to be focused on for searching, which is set based on the actual needs.

The distribution feature of the ROI includes a count of closed ROIs, a distance distribution between the respective closed ROI, and a count of irregular edges in the respective closed ROI.

The distance distribution refers to a distance between the ROI. In some embodiments, for a closed ROI, the path planning module 740 determines the closest edge between the other closed ROI to the ROI and takes the distance as the distance distribution.

The irregular edges refer to edges that do not have a specific regularity, e.g., curved edges, edges where a length of a straight line is less than a preset value, etc.

In some embodiments, the path planning module 740 analyzes a plurality of ROIs to determine the distribution feature of the ROIs in the region to be searched.

In some embodiments, the path planning module 740 determines the sampling point count by vector matching based on the influence value, the device search parameter, and the scene parameter.

In some embodiments, the path planning module 740 constructs a search feature vector, and elements in the search feature vector include the foregoing influence value, the device search parameter, and the scene parameter.

In some embodiments, the path planning module 740 constructs a reference database based on historical data. The reference database includes at least one historical search vector and its corresponding search label. Elements in the historical search vector include, in the historical data, a historical influence value of a historical environment on the plurality of UAVs, a historical search parameter, and a historical scene parameter. The search label includes a historical sampling point count corresponding to the historical search vector in the historical data. In some embodiments, the search label is determined based on the historical sampling point count corresponding to a historical search whose actual traveling path has the smallest deviation value from the planned traveling path in a plurality of historical searches based on the historical search vector.

In some embodiments, the path planning module 740 matches based on the search feature vector in the reference database, determines a historical search vector that has the highest similarity to the search feature vector, and uses the search label corresponding to the historical search vector as the sampling point count corresponding to the search feature vector. The similarity is determined based on a distance between the vectors.

In some embodiments of the present disclosure, by determining the sampling point count based on the device search parameter of the plurality of UAVs, the influence value of the environment on the search of the plurality of UAVs, and the scenario parameter, the actual situation of the plurality of UAVs and the influence of the environment are fully considered, so as to determine a reasonable sampling point count. As a result, when the plurality of UAVs search based on the sampling points, the plurality of UAVs are able to more accurately travel along the planned path to ensure an accuracy of the search.

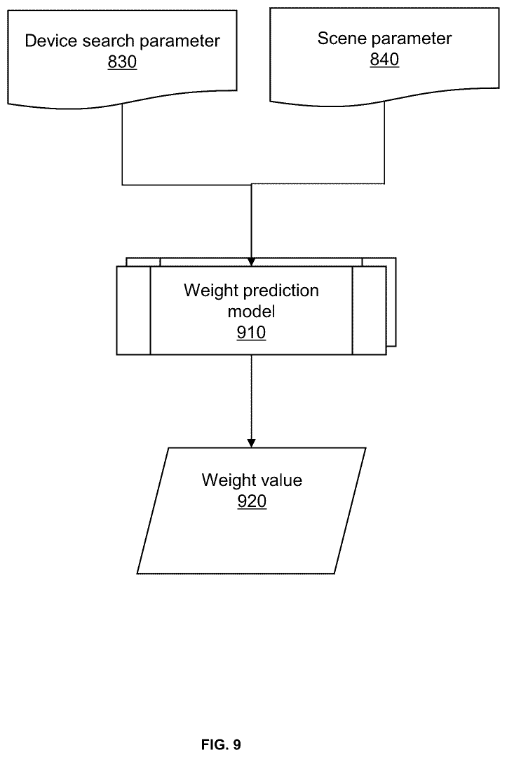

FIG. 9 is a schematic diagram illustrating a process of determining a weight in a target function according to some embodiments of the present disclosure. As shown in FIG. 9, a process of determining the weight in the target function includes the following contents. In some embodiments, the process of determining the weight in the target function is performed by the path planning module 740.

In some embodiments, the path planning module 740 further determines a weight value 920 in the target function based on the device search parameter 830 and the scene parameter 840 through a weight prediction model 910.

The weight prediction model refers to a model used to determine a weight value of the target function.

In some embodiments, the weight prediction model is a machine learning model, e.g., an artificial neural networks (ANN) model, or other machine learning models obtained by training.

In some embodiments, the weight prediction model is stored in the memory 710.

In some embodiments, inputs to the weight prediction model 930 include the device search parameter and the scene parameter, and outputs are a first weight, a second weight, and a third weight in the target function.

Detailed descriptions of the search parameter and the scene parameter and their acquisition may be found in the relevant descriptions in FIG. 8 of the present disclosure.

In some embodiments, the inputs to the weight prediction model further include at least one of a sampling point count, and a changing difference of a heuristic factor.

Detailed descriptions of the sampling point count and its acquisition may be found in FIG. 1 and FIG. 8 of the present disclosure.

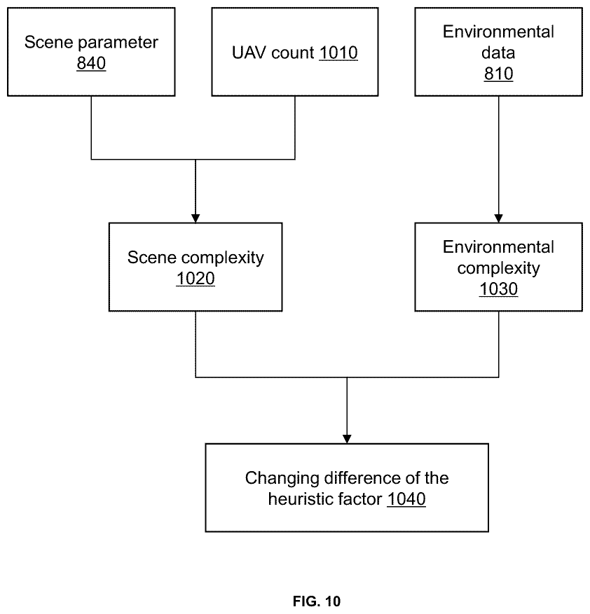

Detailed descriptions of the changing difference of the heuristic factor and the acquisition in an early stage may be found in the relevant descriptions in FIG. 1, and FIG. 10 of the present disclosure.

The sampling point count affects an accuracy of an approximate true distance calculated when planning a path, which affects constraints of a problem total cost model when iterating. Therefore, when determining the weights in the target function of the problem total cost model, considering the sampling point count helps to improve the accuracy of a model output.

The heuristic factor reflects a relative importance of heuristic information in a process of guiding an ant colony search. A value of the heuristic factor reflects an action strength of a priori and deterministic factor in the process of an ant colony optimization. Considering the changing difference of the heuristic factor when determining the target function helps to reflect a convergence speed of the ant colony algorithm to a certain extent, so as to avoid a problem of slow convergence caused by a mismatch between a proportion of a certain weight coefficient and the heuristic factor.

In some embodiments, the weight prediction model is obtained by training an initial prediction model by gradient descent or other possible training methods based on training samples with training labels.

In some embodiments, the training samples include a historical search parameter and a historical scene parameter from historical data. The training labels include a historical first weight, a historical second weight, and a historical third weight, and the training labels are determined based on a weight value corresponding to a historical search operation of subsequent UAVs with the highest search efficiency among the plurality of historical searches corresponding to the training samples. The search efficiency is determined based on a ratio of a sum of a search time and a search energy consumption to a search area.

In some embodiments, the training samples and their corresponding second labels are obtained based on historical search data.

When there is a difference in environments of the regions to be searched, the target functions corresponding to the different regions to be searched are not the same, which is specifically shown by a difference of in size relationships of the first weight, the second weight, and the third weight. When training the model, it is necessary to screen the historical data based on the environmental data to obtain training data that matches the environment of the region to be searched to ensure that a training effect of the model.

In some embodiments, the path planning module 740 screens the training samples used to train the weight prediction model based on historical environmental data.

The historical environmental data refers to the environmental data collected during a historical search process. In some embodiments, the environmental data is collected by a sensor and uploaded to the memory.

In some embodiments, the historical environmental data is obtained from the memory.

In some embodiments, the path planning module 740 determines, based on the historical environment data corresponding to the historical search operation, a reference size relationship between the first weight, the second weight, and the third weight under the historical environmental data through a preset relationship table. When the actual values of the historical first weight, the historical second weight, and the historical third weight corresponding to the historical search operation match the reference size relationship, the historical search parameter and the historical scene parameter corresponding to the historical search operation is taken as one of the training samples, and the historical first weight, the historical second weight, and the historical third weight corresponding to the history search operation are taken as the labels of the training sample; when the actual values of the historical first weight, the historical second weight, and the historical third weight corresponding to the historical search operation does not match the reference size relationship, the data corresponding to the history search operation is rejected.

In some embodiments, the preset relationship table includes a correspondence between the environmental data and the reference size relationship, which is preset by a technician based on the priori experience.

In some embodiments, the path planning module 740 performs the above determination on a plurality of historical search operations in the historical data to select the historical data that satisfies the requirement as a training sample.

According to some embodiments of the present disclosure, selecting the historical data based on the historical environment data excludes some historical data whose weight size does not match a specific environment, thereby ensuring the accuracy of the training labels, and thus ensuring the training accuracy of the weight prediction model.

In some embodiments, the processor trains the initial prediction model by gradient descent based on the training samples and the training labels. Merely as an example, the processor inputs a plurality of training samples with training labels into the initial prediction model, constructs a loss function based on the training labels and an output of the initial prediction model, and iteratively update a parameter of the initial prediction model based on the loss function. The model training is completed when preset conditions are satisfied, and a trained weight prediction model is obtained. The preset condition is that the loss function converges, a count of iterations reaches a threshold, etc.

In some embodiments, in response to completing a preset count of rounds of training, the path planning module adjusts a learning rate of the training based on a decay factor; the preset count of rounds being correlated with an information density of the sub-region.

The preset count of rounds refers to a preset count of iterations. The preset count of rounds is determined based on a standard deviation of the information density of the respective sub-region. In some embodiments, the preset count of rounds is positively correlated to the standard deviation of the information density of the respective sub-region.

The decay factor refers to a decay value of the learning rate of the weight prediction model during iterations. In some embodiments, the decay factor takes a value in a range of 0 to 1. In some embodiments, the decay factor is set by a technician based on experience.

In some embodiments, whenever the weight prediction model is trained for a preset count of rounds, the processor multiplies a current learning rate of the weight prediction model by the decay factor to obtain an adjusted learning rate of the weight prediction model.

The greater the standard deviation of the information density of each sub-region during the search process performed by the plurality of UAVs, the more difficult it is to plan a path to the region to be searched, and the greater an amount of information a training dataset has.

Some embodiments of the present disclosure adjust the learning rate of the weight prediction model according to the standard deviation of the information density of the various sub-regions, so that the weight prediction model learns as many data features of the training set as possible, and at the same time, when the standard deviation of the information density of each sub-region is high, by increasing the count of preset rounds of iteration and delaying a time of the learning rate decay, the weight prediction model better converges to an optimal solution, thereby avoiding a situation of oscillation or failure to converge in the training process.

FIG. 10 is a schematic diagram illustrating a process of determining a changing difference of a heuristic factor according to some embodiments of the present disclosure. As shown in FIG. 10, the process of determining the change difference of the heuristic factor includes the following contents. In some embodiments, the process of determining the change difference of the heuristic factor is performed by a processor.

In some embodiments, the path planning module 740 determines a scene complexity 1020 of a search scene based on a scene parameter 840 and a count of UAVs 1010; determines an environmental complexity 1030 of a current environment based on the environmental data 810; and determines a changing difference 1040 of the heuristic factor based on the scene complexity 1020 and the environmental complexity 1030.

The scene complexity is a parameter indicating a complexity of the scene in which the region to be searched is located.

In some embodiments, the path planning module 740 performs a weighted sum on a sub-region count, a standard deviation of an edge count of closed ROI, and a count of closed RIO, with a value of the weighted summation as an initial complexity. A weight of the weighted summation is set by a technician based on experience.

In some embodiments, the path planning module 740 determines the scene complexity based on the initial scene complexity, and the count of UAVs, by querying a complexity reference table.

The complexity reference table includes a correspondence between a reference initial scene complexity, a reference count of UAVs, and a reference scene complexity. In some embodiments, the complexity reference table is set by a technician based on experience.

The environmental complexity refers to a complexity of a current environment searched.

In some embodiments, the path planning module 740 uses an average value of standard deviations of data of a humidity, a temperature, a wind speed, and a wind direction at a plurality of point positions in the region to be searched as the environmental complexity. The humidity, the temperature, the wind speed, and the wind direction are collected by environmental sensors loaded on the UAV 730.

In some embodiments, when the environmental complexity is greater than a preset threshold, the path planning module 740 increases the scene complexity by a preset adjustment amount to obtain an adjusted scene complexity; and determines, based on the adjusted scenario complexity, the changing difference of the heuristic factor by querying a reference difference table.

The reference difference table contains a correspondence between the scene complexity and the changing difference of the heuristic factor. In some embodiments, the reference difference table is set by the technician based on experience.

In some embodiments, the preset threshold is set by the technician based on experience.

In some embodiments, the preset threshold is related to a cell count in the region to be searched. Exemplarily, the greater the cell count in the region to be searched, the smaller the preset threshold.

In some embodiments, the preset adjustment amount is set by the technician based on experience.

The greater the cell count in the region to be searched, the more choices the UAV has when performing the path planning, and the greater an impact of the environmental data at each point position on the path planning at this time.

In some embodiments of the present disclosure, by determining the environmental complexity of the current search environment based on the environmental data and adjusting the scene complexity by a preset threshold, and then determining the changing difference of the heuristic factor based on the adjusted scene complexity, the changing difference of the heuristic factor is more accurate where there are a greater count of cells, so that the determination of the changing difference of the heuristic factor is more accurate.

The foregoing is only a preferred embodiment of the present disclosure, and is not intended to limit the present disclosure, and any modifications, equivalent substitutions, improvements, etc., made within the spirit and principles of the present disclosure shall be included in the scope of protection of the present disclosure.

What is claimed is:

1. A system for multi-unmanned aerial vehicle (UAV) collaborative coverage path planning based on a Q-learning adaptive ant colony algorithm, wherein the system includes a memory, an image collection device, and a plurality of UAVs; and
the memory is communicatively connected to the image collection device and the plurality of UAVs; wherein
the image collection device is configured to collect an environmental image of a region to be searched and store the environmental image to the memory;
the plurality of UAVs are loaded with a path planning module configured to:
construct a three-dimensional (3D) model in a collaborative coverage environment based on the environmental image through a first preset program obtained from the memory, obtain information of the region to be searched from the memory, and by performing a cell division on the 3D model based on a scanning range of an airborne radar of each of the plurality of UAVs, obtain one or more sub-regions;
by establishing constraints of the plurality of UAVs and the environment based on the determined 3D model of the region to be searched, establish a problem total cost model;
perform a plurality of rounds of iterations, wherein each round of iteration includes:
setting an initial pheromone concentration based on the one or more sub-regions formed by the scanning range of the airborne radar, by solving the problem total cost model using a second preset program obtained from the memory, obtaining a preliminary planning path; the second preset program including an ant colony algorithm; and
determining whether a count of iterations is greater than 1, in response to determining that the count of iterations is greater than 1, augmenting a pheromone using an elite strategy while adaptively adjusting a heuristic factor with a third preset program obtained from the memory; in response to determining that the count of iterations is not greater than 1, augmenting the pheromone using the elite strategy; the third preset program including a Q-learning; and
calculate a reward value of each ant colony and determine whether a maximum iteration count is reached, in response to determining that the maximum iteration count is reached, enter a new round of iteration, in response to determining that the maximum iteration count is reached, output a path corresponding to a current round of iteration as a final path.

2. The system of claim 1, wherein the path planning module is further configured to:
by performing an image processing on the environmental image, extract an information density in the region to be searched;
call a corresponding 3D modeling program from the memory based on the information density and an area of the region to be searched; and
through the 3D modeling program, determine a model accuracy based on the information density and the area of the region to be searched, and construct the 3D model based on the model accuracy.

3. The system of claim 2, wherein the path planning module is further configured to:
obtain the information density of the one or more sub-regions; and
adjust the initial pheromone concentration in the one or more sub-regions based on the information density.

4. The system of claim 1, wherein the path planning module is further configured to:
control a group of UAVs U={U₁, U₂, . . . , Uₙ} with n count of UAVs to perform a search task in m count of sub-regions located in a maximal search region R, the sub-regions being R₁, R₂, . . . , Rₘ, and {R₁, R₂, . . . , Rₘ}∈R;
control the plurality of UAVs to fly at a constant altitude with respect to a scanning surface, wherein a scanning region of one or more airborne sensors to a ground is a square with a side length d, the plurality of UAVs have a variable maximum flight time Tₘₐₓ, in a process of performing a task, the plurality of UAVs are required to return to a base station before running out of energy; the plurality of UAVs are denoted as Uᵢ=<Tₘₐₓ, Tₛ, E_{c}>, wherein Tₘₐₓ denotes a maximum flight time of the ith UAV Uᵢ, Tₛ denotes a remaining flight time of the UAV, and E_{c} denotes an energy consumption of the UAV;
perform a 2-dimensional (2D) cell division in an overlooking view of the maximum search region R according to the scanning range of the airborne radar, wherein each divided cell is a region that needs to be scanned once in a constant height relative to a ground height of the region, and each cell grid region has a corresponding height and a Boolean value, denoted as Dₖ=<Hₖ,B>, a height value Hₖ denotes a Z-axis coordinate of a kth cell grid region, and the Boolean value B∈{0,1}denotes whether the kth scanned region is a region of interest (ROI); if the cell grid region Dₖ belongs to{R₁, R₂, . . . , Rₘ}, the Boolean value is 0, if the cell grid region Dₖ does not belong to {R₁, R₂, . . . , Rₘ}, the Boolean is 1.

5. The system of claim 4, wherein the path planning module is further configured to:
perform a grid region decomposition on the maximum search region R based on the side length d of the scanning region of the search range of each of the plurality of UAVs, wherein the grids are placed adjacent to each other and each cell grid region D is numbered by horizontal and vertical coordinates of its position, wherein the cell grid regions are numbered as follows:
$$Number = ( {R}_{1} / d ) \times x + y ;$$
wherein R₁ denotes a measured length of the maximum search region R, d denotes a side length of the scanning region of the UAV, and x and y respectively denote horizontal and vertical coordinates of a position of the cell grid region.

6. The system of claim 4, wherein the constraints of the problem total cost model include at least one of a flight time constraint, a flight altitude, a flight speed constraint, and a scan count constraint for the plurality of UAVs; wherein
the flight time constraint includes:
$${P}_{i} = \{ \begin{matrix}{D}_{ki} & ∀ ( {T}_{s} - {T}_{ki , kj} - {T}_{j 0} ) > 0 \\ {P}_{0} & others\end{matrix} ;$$
$$\{ \begin{matrix}{T}_{ki , kj} = {D}_{ki ( kj - num )} + {D}_{( ki + num ) ( kj - num )} + … + {D}_{( ki + num ) kj} \\ num = ⌈ {D}_{kikj} / d ⌉ \times 5\end{matrix}$$
wherein Pᵢ denotes a selection of a next track point of the UAV when the UAV is in a cell grid region Dₖᵢ; P₀ denotes ae base station, which is a starting track point for all the UAVs; Dₖᵢ denotes an ith cell grid region; Tₛ denotes a remaining flight time of the UAV Uᵢ; T_{ki,kj} denotes a time required for the UAV to fly from the cell grid region Dₖⱼ to the cell grid region Dₖⱼ; Tⱼ₀ denotes a time required to fly from the cell grid region Dₖⱼ to the base station; Dₖᵢₖⱼ denotes an Euclidean distance for the UAV to fly from the cell grid region Dₖᵢ to the cell grid region Dₖⱼ, and num denotes a count of sampling points obtained in a middle of the cell grid regions Dₖᵢ and Dₖⱼ;
the flight altitude and flight speed constraint includes:
$$\{ \begin{matrix}{U}_{i}^{AF} = {H}_{i} + a \\ {U}_{i}^{SF} = b\end{matrix} a , b ∈ C ; i ∈ \{ 1 , 2 , … n \} ;$$
wherein Uᵢ^{SF} denotes a flight speed; Hi denotes a ground altitude of the ith UAV Uᵢ in a current region; a, b are constants; n denotes a count of UAVs; Uᵢ^{AF} denotes a current flight altitude of the UAV Uᵢ, C is a constant sign;
the scan count constraint includes: scanning each cell grid region only once by one UAV, changing a Boolean value B of the cell grid region to 1 after the scanning is completed, and no other UAV is allowed to enter the region, that is:
Σᵢ₌₁ⁿDₖᵢⁱ=1∀i∈{1,2, . . . ,n};
wherein Dₖᵢⁱ denotes the Boolean value of the cell grid region Dₖᵢ after scanning by all the UAVs Uᵢ, . . . , Uₙ.

7. The system of claim 6, wherein each of the plurality of UAVs is further loaded with an environmental sensor module; and the path planning module is further configured to:
obtain environmental data through the environmental sensor module;
determine, based on the environmental data, an influence value of current environment on a traveling path of each of the plurality of UAVs; and
determine a sampling point count based on the influence value, a device search parameter, and a scene parameter.

8. The system of claim 6, wherein a target function of the problem total cost model includes: a surrogate value obtained by evaluating a search and rescue coverage path of each of the plurality of UAVs, the surrogate value being a sum of a coverage rate of the ROI and a reward value for energy saving:
$${f}_{total} = {W}_{1} {f}_{c} + {W}_{2} {f}_{t} + {W}_{3} {f}_{a} ;$$
wherein fₜₒₜₐₗ denotes the target function, which is obtained by a weighted summation of a coverage rate f_{c}, a flight time fₜ, and a total turning angle cost fₐ; W₁, W₂, and W₃ respectively denote weight values of the coverage rate f_{c}, the flight time fₜ, and the total turning angle cost fₐ;
the coverage rate f_{c} is:
$${f}_{c} = \frac{{\sum }_{ki = 1}^{( \frac{{R}_{l} {R}_{w}}{{d}^{2}} )} {D}_{ki} 〈 B 〉 - {\sum }_{i = 1}^{( \frac{{R}_{l} {R}_{w}}{{d}^{2}} )} {D}_{ki}^{′} 〈 B 〉}{( \frac{{R}_{l} {R}_{w}}{{d}^{2}} ) - {\sum }_{ki = 1}^{( \frac{{R}_{l} {R}_{w}}{{d}^{2}} )} {D}_{ki}^{′} 〈 B 〉} \times 100 \% ;$$
wherein Rₗ and R_{w} respectively denote a length and a width of the maximum search region, Dₖᵢ denotes a Boolean value B of the kith cell grid region Dₖᵢ, and D′ₖᵢ denotes a Boolean value B of the kith cell grid region Dₖᵢ when the search is completed, D′ₖᵢ denotes a Boolean value B of the kith cell grid region; d denotes a scanning range of the airborne sensor, a value of
$$\frac{{R}_{l} {R}_{w}}{{d}^{2}}$$
is a total count of all cell grid regions;
the flight time fₜ is:
fₜ=TΣₖ₌₁^{K}Sₖ_{ₘₐₓ}^{d};
wherein Tₘₐₓ denotes a maximum flight time of the UAV Uᵢ; K denotes a total track count flown at an end of the search of the UAV Uᵢ; and Sₖ^{d} denotes a true distance of a kth step of the track;
the total turning angle cost fₐ is:
$${f}_{a} = \frac{1}{K} {\sum }_{k = 1}^{K} {S}_{k}^{a} / π ;$$
wherein Sₖ^{a} denotes a turning time of a kth track.

9. The system of claim 8, wherein the path planning module is further configured to:
determine the weight values in the target function by a weight prediction model based on a device search parameter and a scene parameter; wherein
the weight prediction model is a machine learning model stored in the memory.

10. The system of claim 9, wherein inputs to the weight prediction model further includes at least one of a sampling point count and a changing difference of the heuristic factor.

11. The system of claim 9, wherein the path planning module is further configured to:
screen training samples for training the weight prediction model based on historical environmental sensor data.

12. The system of claim 9, wherein the path planning module is further configured to:
obtain a trained weight prediction model by training an initial weight prediction model based on the training samples with labels; and
in response to completing a preset count of rounds of training, adjust a learning rate of the training based on a decay factor; the preset count of rounds being correlated with an information density of the sub-region.

13. The system of claim 8, wherein the path planning module is further configured to:
select and access, from the base station, the cell grid region corresponding to a next moment one by one based on ants according to a pheromone concentration and heuristic information;
a selection probability for one cell grid region is:
$${P}_{kikj}^{k} = \{ \begin{matrix}\frac{{{[ {τ}_{kikj} ( t ) ]}^{α} [ {η}_{kikj} ( t ) ]}^{β}}{{{{\sum }_{u ∈ allowed} [ {τ}_{kiu} ( t ) ]}^{α} [ {η}_{kiu} ( t ) ]}^{β}} & j ∈ allowed \\ 0 & others\end{matrix}$$
wherein τₖᵢₖⱼ(t) denotes a pheromone concentration left by a path between a cell grid region Dᵢ to a cell grid region Dⱼ at a moment t; ηₖᵢₖⱼ(t) denotes heuristic information from the cell grid region Dᵢ to the cell grid region Dⱼ; α and β respectively denote a pheromone factor and a heuristic factor; allowed denotes all regions that are able to be selected in the cell grid region Dᵢ; τₖᵢᵤ(t) and ηₖᵢᵤ(t) respectively denote a pheromone concentration and heuristic information from the cell grid region Dᵢ to the cell grid region Dᵤ; and
in response to determining that the ants complete a task and return to the base station and an iterative search ends, update the pheromone between the cell grid regions based on a result of the iterative search.

14. The system of claim 13, wherein a formula for determining the initial pheromone concentration is:
$${τ}_{kikj}^{0} = 1 / {T}_{kikj} ;$$
wherein τₖᵢₖⱼ⁰ denotes an initial pheromone concentration from the cell grid region Dₖᵢ to the cell grid region Dₖⱼ, Tₖᵢₖⱼ denotes a true distance from the cell grid region Dₖⱼ; to the cell grid region Dₖⱼ;
the heuristic information is: ηₖᵢₖⱼ=1/dₖᵢₖⱼ;
wherein dₖᵢₖⱼ denotes a distance from the cell grid region Dᵢ to the cell grid region Dⱼ;
the path planning module is further configured to:
update the pheromone concentration of the current path based on a degree of superiority of the current path that the ants are traveling through, the pheromone concentration decreasing over time;
equations for updating the pheromone concentration include:
$${τ}_{kikj}^{am} ( t + 1 ) = ( 1 - ρ ) {τ}_{kikj}^{am} ( t ) + {\sum }_{am = 1}^{AM} Δ {τ}_{kikj}^{am} ( t ) ;$$
$$Δ {τ}_{kikj}^{am} ( t ) = \{ \begin{matrix}\frac{Q}{{L}_{reward}} & i f the amth ant files from region {D}_{ki} to {D}_{kj} ; \\ 0 & other situations\end{matrix}$$
wherein ρ denotes a global pheromone volatilization factor with a value of (0,1); τₖᵢₖⱼ^{am}(t) denotes a pheromone concentration of a path traveled by an amth ant at a moment t; Δτₖᵢₖⱼ^{am}(t) denotes a change in pheromone concentration of the amth ant on a path from the cell grid region Dₖᵢ to the cell grid region Dₖⱼ at the moment t; and Q is a pheromone updating intensity factor constant; L_{reward} denotes a degree of superiority of the path from the cell grid region Dₖᵢ to the cell grid region Dₖⱼ, AM denotes a total count of ants, and τₖᵢₖⱼ^{am}(t+1) denotes a pheromone concentration of a path traveled by the amth ant in a next moment of the moment t.

15. The system of claim 14, wherein the path planning module is further configured to:
update the pheromone after the ants have completed the path by an elite solution, the elite solution being set at ¼ of a population size; and
update, based on the elite solution, the pheromone concentration of the ant colony to:
$${τ}_{kikj}^{am} ( t + 1 ) = ( 1 - ρ ) {τ}_{kikj}^{am} ( t ) + 4 \times {\sum }_{am = 1}^{AM} {Δτ}_{kikj}^{am} ( t ) .$$

16. The system of claim 13, wherein the path planning module is further configured to:
perform a path planning for an initial population using the ant colony algorithm, record the coverage rate, the energy consumption, and a time remaining reward when initializing; generate a q table with 3-rows and 3-column that all initial data is 0 after updating the pheromone based on the initial pheromone concentration, and randomly select one group of states therefrom; and
starting from a second generation, divide the population into three sub-populations, one population corresponds to one action in the q table, and determine a current moment state based on a relationship between magnitudes of the coverage rates fc and magnitudes of the energy consumptions fa of the current moment and a previous moment; determine a target movement based on the current moment state and a Q value; and dynamically and adaptively adjust a parameter size of the heuristic factor based on the target action.

17. The system of claim 16, wherein an initial q table is initialized as:

| | action | | |
|---|---|---|---|
| S(t) | β = β + Δβ | β = β − Δβ | β = β |
| c_{g}^{t} < c_{g-1}^{t} | 0 | 0 | 0 |
| c_{g}^{t} = c_{g-1}^{t} | 0 | 0 | 0 |
| c_{g}^{t} > c_{g-1}^{t} | 0 | 0 | 0 |

in the table, S(t) denotes a state of a population of current generation; c_{g}^{t}=f_{c}+fₐ denotes a total cost at the moment t; c_{g-1}^{t} denotes a total cost of a previous generation g−1, β denotes a heuristic factor parameter, and Δβ denotes a changing difference of the heuristic factor β;
the path planning module is further configured to:
in response to completing initialization, in the second generation, divide the population into three sub-populations with a same size, wherein the three sub-populations operate in parallel, one sub-population corresponds to one action, and different sub-populations adopts different heuristic factors, the heuristic factors are respectively β+Δβ, β−Δβ, and β; after the completion of one generation of path planning, determine the Q values corresponding to each of the three actions, and update the q table;
a selection strategy for the sub-population is:
$${P}_{kikj}^{k} ( t ) = \{ \begin{matrix}\frac{{{[ {τ}_{kikj} ( t ) ]}^{α} [ {η}_{kikj} ( t ) ]}^{β + Δ β}}{{{{\sum }_{ku ∈ allowed} [ {τ}_{kiku} ( t ) ]}^{α} [ {η}_{kiku} ( t ) ]}^{β + Δβ}} & j ∈ allowed \\ 0 & others\end{matrix}$$
wherein Pₖᵢₖⱼ^{k}(t) denotes a selection probability of the cell grid region at a t moment;
the update strategy for the Q value is:
$$Q ( {S}_{g} , {A}_{g} ) = Q ( {S}_{g} , {A}_{g} ) + φ ( {R}_{g + 1} + λ {max}_{a} Q ( {S}_{g + 1} , a ) - Q ( {S}_{g} , {A}_{g} ) ) ;$$
wherein Q(S_{g}, A_{g}) denotes a Q value corresponding to an action Ag of state Sg in generation g;
$${max}_{a} Q ( {S}_{g + 1} , a )$$
denotes a maximum Q value among all the actions in generation g+1; R_{g+1} denotes a reward value corresponding to generation g+1, and denotes a mean value of the target function fₜₒₜₐₗ of the sub-populations; φ denotes a learning rate of historical information; and A denotes an estimated value of a future expectation.

18. The system of claim 9, wherein the path planning module is further configured to:
determine a scene complexity of a search scene based on a scene parameter and a count of UAVs;
determine an environmental complexity of a current environment based on environmental data; and
determine a changing difference of the heuristic factor based on the scene complexity and the environmental complexity.

19. The system of claim 1, wherein the path planning module is further configured to:
determine an outlier risk point and a collision risk point when the plurality of UAVs are traveling on the final path based on the final path;
in response to determining that the plurality of UAVs reach the outlier risk point, determine a communication frequency and control the plurality of UAVs to communicate with a control center based on the communication frequency; and
determine an acceleration threshold of the plurality of UAVs, and in response to determining that an acceleration of the plurality of UAVs approaches a warning value, control the plurality of UAVs to lock a power valve and/or adjust a propeller attitude, so as to limit the acceleration of the plurality of UAVs.
